(19) United States
(12) Patent Application Publication
(10) Pub. No.: US 2024/0224296 A1
(43) Pub. Date: Jul. 4, 2024

(54) METHOD AND APPARATUS FOR REQUESTING SIDELINK POSITIONING REFERENCE SIGNAL RESOURCE IN A WIRELESS COMMUNICATION SYSTEM

(71) Applicant: ASUS Technology Licensing Inc., Taipei City (TW)

(72) Inventors: Ming-Che Li, Taipei City (TW); Yi-Hsuan Kung, Taipei City (TW); Li-Chih Tseng, Taipei City (TW); Chun-Wei Huang, Taipei City (TW); Li-Te Pan, Taipei City (TW)

(21) Appl. No.: 18/400,676

(22) Filed: Dec. 29, 2023

Related U.S. Application Data
(60) Provisional application No. 63/436,938, filed on Jan. 4, 2023.

(51) Int. Cl. H04W 72/25; H04L 5/00

(52) U.S. Cl. CPC H04W 72/25; H04L 5/0048

(57) ABSTRACT

Methods, systems, and apparatuses are provided for a first device receiving configuration of one or more sidelink resource pools enabled or supported for sidelink reference signal transmission, triggering one or more sidelink reference signal resource requests for performing one or more sidelink reference signal transmissions, generating a first message for sidelink reference signal, wherein the first message for sidelink reference signal comprises information of the one or more sidelink reference signal resource requests, and wherein information of a sidelink reference signal resource request comprises any of a priority of sidelink reference signal, a destination index or Identity (ID) of sidelink reference signal, and a bandwidth (requirement) of sidelink reference signal, and transmitting the first message for sidelink reference signal to a network node.

### CROSS-REFERENCE TO RELATED APPLICATIONS

The present Application claims priority to and the benefit of U.S. Provisional Patent Application Ser. No. 63/436,938, filed Jan. 4, 2023, which is fully incorporated herein by reference.

### FIELD

This disclosure generally relates to wireless communication networks and, more particularly, to a method and apparatus for requesting sidelink positioning reference signal resource in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for requesting sidelink positioning reference signal resource in a wireless communication system. A User Equipment (UE) can request a Sidelink (SL) Positioning Reference Signal (PRS) from a network node based on information or requirements of position/ranging and/or based on a utilization situation of a sidelink grant for SL-PRS.

In various embodiments, a method of a first device comprises receiving configuration of one or more sidelink resource pools enabled or supported for sidelink reference signal transmission; triggering one or more sidelink reference signal resource requests for performing one or more sidelink reference signal transmissions; generating a first message for sidelink reference signal, wherein the first message for sidelink reference signal comprises information of the one or more sidelink reference signal resource requests, and wherein information of a sidelink reference signal resource request comprises any of a priority of sidelink reference signal, a destination index or Identity (ID) of sidelink reference signal, and a bandwidth (requirement) of sidelink reference signal; and transmitting the first message for sidelink reference signal to a network node.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure 6.1.3.33-1: SL-BSR and Truncated SL-BSR MAC control element, from 3GPP TS 38.321 V17.2.0 (2022-09).

FIG. 6 is a reproduction of Figure 6.1.3.35-1: Sidelink CSI Reporting MAC CE, from 3GPP TS 38.321 V17.2.0 (2022-09).

FIG. 7 is a reproduction of Figure 6.20.3.1-1: MT-LR procedure for Network assisted Sidelink positioning in Network Coverage case (UE1 is in Network Coverage), from 3GPP TR 23.700-86 V1.2.0.

FIG. 8 is a reproduction of Figure 6.20.3.2-1: MO-LR procedure for Network assisted Sidelink positioning in Network Coverage case (UE1 is in Network Coverage), from 3GPP TR 23.700-86 V1.2.0.

FIG. 9 is a reproduction of Figure 6.20.3.3-1: MO-LR procedure for Network assisted Sidelink positioning in Partial Coverage case (UE1 is out of Network Coverage, UE2 is in Network Coverage), from 3GPP TR 23.700-86 V1.2.0.

FIG. 10 shows possible steps, behaviors, procedures, and/or operations that may be performed for SL-PRS, in accordance with embodiments of the present invention.

FIG. 11 is a flow diagram of a method of a first device comprising being configured with one SR configuration for sidelink reference signal, wherein the first device triggers/requests to transmit a sidelink reference signal with associated information/pattern or requirement, determining/deriving a PUCCH resource or a SR resource for sidelink reference signal, and transmitting a scheduling request for the sidelink reference signal, in accordance with embodiments of the present invention.

FIG. 12 is a flow diagram of a method of a first device comprising being configured with one SR configuration for sidelink reference signal, triggering/requesting to transmit a sidelink reference signal, determining/deriving a PUCCH resource or a SR resource, and transmitting a scheduling request for the sidelink references signal on the PUCCH resource, in accordance with embodiments of the present invention.

FIG. 13 is a flow diagram of a method of a first device comprising having one or more sidelink reference signal triggering/requesting, trigger to transmit one or more requests for sidelink reference signal, receiving a sidelink grant for scheduling, performing one or more multiple sidelink reference signal transmissions, and transmitting the remaining pending request(s) for sidelink reference signal, in accordance with embodiments of the present invention.

FIG. 14 is a flow diagram of a method of a first device comprising receiving configuration of one or more sidelink resource pools, triggering one or more sidelink reference signal resource requests, generating a first message for sidelink reference signal, and transmitting the first message for sidelink reference signal, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on.

These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.213 V17.4.0 (2022-12) 3GPP; TSG RAN; NR; Physical layer procedures for control (Release 17); [2] 3GPP TS 38.214 V17.4.0 (2022-12) 3GPP; TSG RAN; NR; Physical layer procedures for data (Release 17); [3] 3GPP TS 38.212 V17.4.0 (2022-12) 3GPP; TSG RAN; NR; Multiplexing and channel coding (Release 17); [4] 3GPP TS 38.321 V17.2.0 (2022-09) 3GPP; TSG RAN; NR; Medium Access Control (MAC) protocol specification (Release 17); [5] RP-213588, “Revised SID on Study on expanded and improved NR positioning”, Intel; [6] RAN1 Chair's Notes of 3GPP TSG RAN WG1 #109-e; [7] RAN1 Chair's Notes of 3GPP TSG RAN WG1 #110; [8] RAN1 Chair's Notes of 3GPP TSG RAN WG1 #110bis-e; [9] RAN1 Chair's Notes of 3GPP TSG RAN WG1 #111; [10] 3GPP TR 23.700-86 V1.2.0 “Study on Architecture Enhancement to support Ranging based services and sidelink positioning (Release 18)”; and [11] 3GPP TS 23.273 V17.6.0 “5G System (5GS) Location Services (LCS); Stage 2 (Release 17)”. The standards and documents listed above are hereby expressly and fully incorporated herein by reference in their entirety.

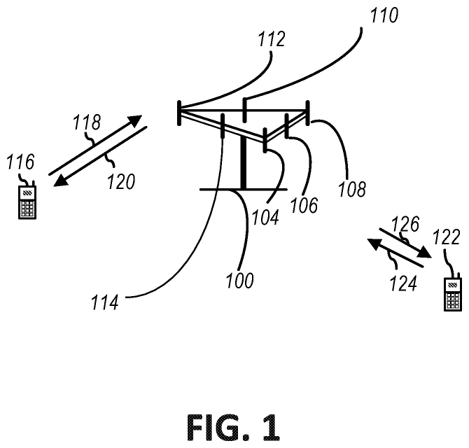

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

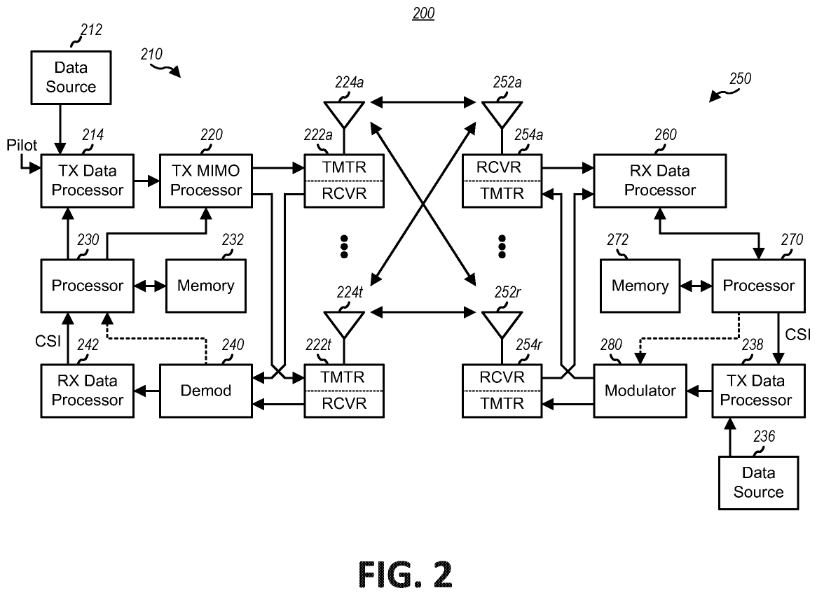

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

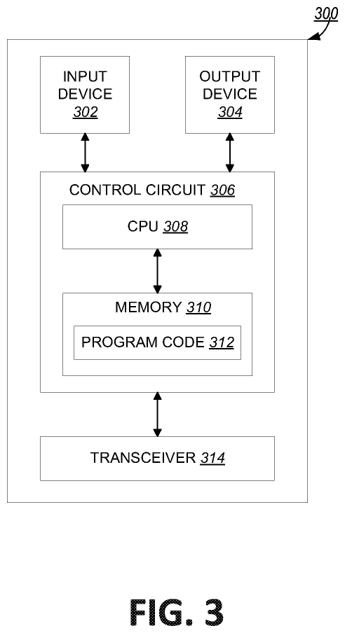

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

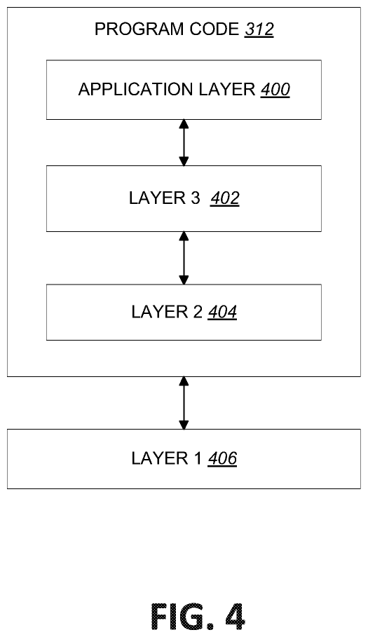

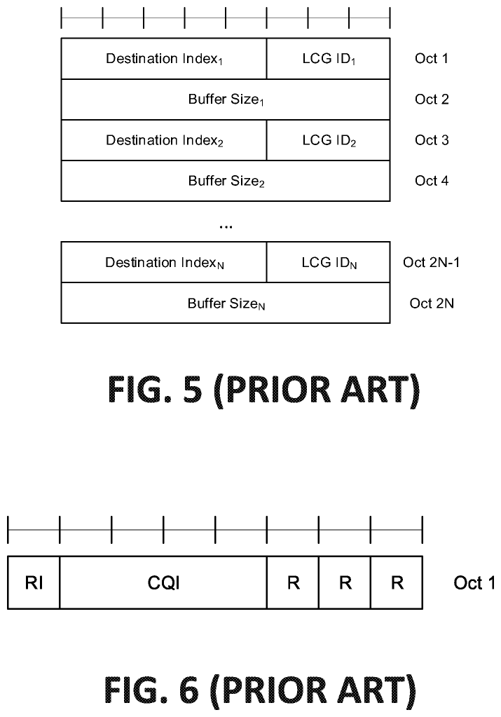

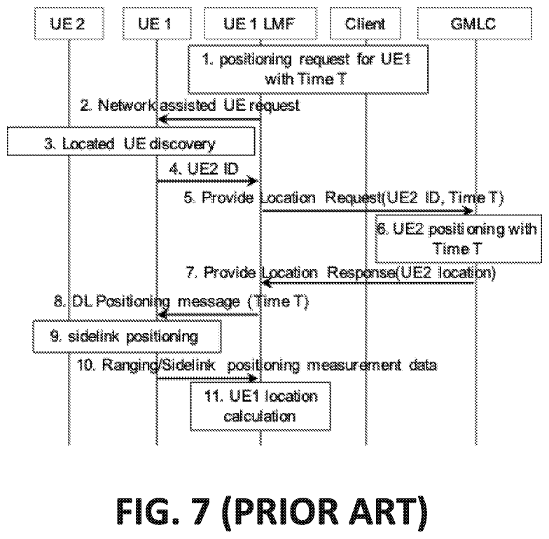

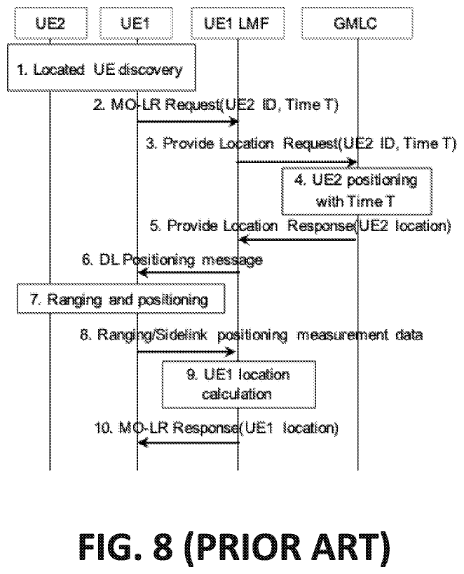

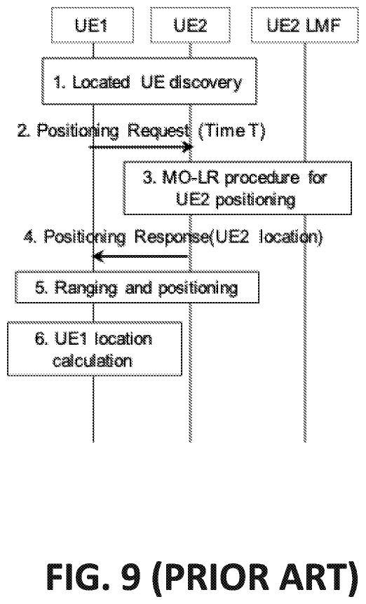

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

Any two or more than two of the following paragraphs, (sub-)bullets, points, actions, or claims described in each invention paragraph or section may be combined logically, reasonably, and properly to form a specific method.

In TS 38.213 (e.g., [1] 3GPP TS 38.213 V17.4.0 (2022-12) 3GPP; TSG RAN; NR; Physical layer procedures for control (Release 17)), scheduling request (SR) via PUCCH is specified.

For New Radio (NR) Release-16/17 sidelink design, sidelink slots can be utilized for Physical Sidelink Broadcast Channel (PSBCH) or Physical Sidelink Control Channel (PSCCH)/Physical Sidelink Shared Chanel (PSSCH)/Physical Sidelink Feedback Channel (PSFCH) transmission/reception. PSBCH is Time Division Multiplexing (TDMed), in slot level, from PSCCH/PSSCH/PSFCH. It means that the sidelink slots except slots for PSBCH can be utilized for PSCCH/PSSCH/PSFCH transmission/reception. Moreover, the concept of sidelink resource pool for sidelink communication is utilized for PSCCH/PSSCH and/or /PSFCH transmission/reception. A sidelink (communication) resource pool will comprise a set of sidelink slots (except slots for PSBCH) and a set of frequency resources. Different sidelink (communication) resource pools may be TDMed and/or Frequency Division Multiplexing (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in another/other sidelink (communication) resource pool. For a PSCCH/PSSCH, an associated PSFCH is in the same sidelink (communication) resource pool, instead of in different sidelink (communication) resource pools.

One sidelink (communication) resource pool will comprise multiple sub-channels in frequency domain, wherein a sub-channel comprises multiple contiguous Physical Resource Blocks (PRBs) in frequency domain. One PRB comprises multiple Resource Elements (REs), e.g., one PRB consists of 12 REs. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, a fixed relationship between the PSCCH and the PSSCH resource is specified, which means that the PSCCH will be located in the lowest (index of) the sub-channel of the scheduled PSSCH resource. As for scheduled PSSCH resource in different slot(s), the starting frequency position of the scheduled PSSCH resource will be scheduled/indicated by sidelink control information, instead of a fixed relationship.

In current NR Release-16/17 sidelink design, one Sidelink Control Information (SCI) could indicate at most three PSSCH resources via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexing with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources are utilized/associated with a same data packet, e.g., a same Transport Block (TB) or a same Medium Access Control (MAC) Packet Data Unit (PDU). Note that standalone PSCCH/SCI is not supported in NR sidelink, which means that for each PSSCH transmission in a slot, there will be a corresponding PSCCH/SCI transmission in the same slot, and vice versa.

Moreover, resource reservation for another TB by a SCI could be (pre-)configured as/with enabled or not enabled or not configured in a sidelink (communication) resource pool. When a sidelink (communication) resource pool is configured with enabled such resource reservation, the sidelink (communication) resource pool is configured with a set of reservation period values. Possible reservation periods could be 0, 1:99, 100, 200, 300, 400, 500, 600, 700, 800, 900, 1000 ms. A resource reservation period field in a SCI in the sidelink (communication) resource pool could indicate which reservation period value for (future) resource reservation. The size/number of the set of reservation period values could be from 1 to 16.

In current NR Release-16/17 sidelink design, there are two sidelink resource allocation modes defined for NR sidelink communication:
Mode 1 is that a base station/network node can schedule sidelink resource(s) to be used by a User Equipment (UE) for sidelink transmission(s); and/or
Mode 2 is that a UE determines (i.e., base station/network node does not schedule) sidelink transmission resource(s) within sidelink resources configured by a base station/network node or pre-configured sidelink resources.

For network scheduling mode, e.g., NR sidelink resource allocation mode 1, the network node may transmit a sidelink (SL) grant, e.g., Downlink Control Information (DCI) format 30, on Uu interface for scheduling at most three PSSCH resources (for a same data packet). The Transmitting (TX) UE may perform PSCCH and PSSCH transmissions on PC5 interface, in response to the received sidelink grant, for a data packet. The Uu interface means the wireless interface for communication between the network and the UE. The PC5 interface means the wireless interface for communication (directly) between UEs/devices.

For UE (autonomous) selection mode, e.g., NR sidelink resource allocation mode 2, since transmission resource is not scheduled via network node, the UE may require performing sensing before selecting a resource for transmission (e.g., sensing-based transmission), in order to avoid resource collision and interference from or to other UEs (especially UEs using NR sidelink). Based on the result of the sensing procedure, the UE can determine a valid/identified resource set. The valid/identified resource set may be reported to higher layers (of the UE). The UE may (randomly) select one or multiple valid/identified resources from the valid/identified resource set to perform sidelink transmission(s) from the UE. The sidelink transmission(s) from the UE may be a PSCCH and/or a PSSCH transmission.

For a TX UE configured in NR sidelink resource allocation mode 1, when the TX UE has available sidelink data for transmission and does not have scheduled/reserved PSSCH/PSCCH resources for transmitting the available sidelink data, the TX UE may transmit a Scheduling Request (SR) (on Physical Uplink Control Channel (PUCCH) resource) to the network node for requesting resources. The SR resource or the PUCCH resource of the scheduling request may be configured by network. The SR resource or the PUCCH resource of the scheduling request may be based on a SR configuration associated with a sidelink logical channel with available sidelink data for transmission. When the network receives/detects the scheduling request from the TX UE, the network may schedule UL resource to the TX UE. The TX UE can report/transmit a Sidelink Buffer Status Report/Reporting (SL-BSR), comprising information (e.g., buffer size, total amount of data) of the available sidelink data associated with/from one or more sidelink logical channel(s), to the network node via the scheduled UL resource. Based on the SL-BSR, the network node may transmit sidelink grant(s) for scheduling PSSCH/PSCCH resources to the TX UE. Furthermore, when the TX UE has a SL Channel State Information (CSI) report (e.g., sidelink CSI Reporting MAC Control Element (CE)) for transmission and does not have scheduled/reserved PSSCH/PSCCH resources for transmitting the SL CSI report, the TX UE may transmit an SR to the network node for requesting sidelink resources. The SR resource or the PUCCH resource of the scheduling request may be based on one SR configuration associated with SL CSI reporting. When the network receives/detects the scheduling request from the TX UE, the network may transmit sidelink grant(s) for scheduling PSSCH/PSCCH resources to the TX UE. Note that sidelink buffer status report does not comprise information of MAC CE(s) (e.g., sidelink CSI Reporting MAC CE).

In NR Release 17, positioning on Uu interface is supported. Downlink (DL) Positioning Reference Signal (PRS) and Uplink (UL) Sounding Reference Signal-Positioning (SRS-Pos) are specified as Positioning RS for supporting NR positioning functionality. Some positioning methods are introduced, such as Time Difference of Arrival (TDoA), Round Trip Time (RTT), Angle of Arrival (AoA), and/or Angle of Departure (AoD). For time-based positioning methods, larger bandwidth for Positioning RS is required for higher accuracy positioning.

In NR Release-18, it will also study feasibility of potential solutions for SL positioning, considering relative positioning, ranging and absolute positioning, wherein the SL positioning is operated in a device-to-device interface or said PC5-interface between device and device. The device can mean or be replaced as UE.

In RAN1 meetings [6]-[9] (RAN1 Chair's Notes of 3GPP TSG RAN WG1 #109-e; RAN1 Chair's Notes of 3GPP TSG RAN WG1 #110; RAN1 Chair's Notes of 3GPP TSG RAN WG1 #110bis-e; and RAN1 Chair's Notes of 3GPP TSG RAN WG1 #111), RAN1 agreed to study RTT-type solutions using SL, SL-AoA, SL-TDOA, SL-AoD with regard to positioning methods supported using SL measurements. Accordingly, a new reference signal for SL positioning/ranging will be introduced. The new reference signal for SL positioning/ranging may be noted as SL-PRS. For supporting time-based positioning methods, larger bandwidth for SL-PRS is required for higher accuracy positioning. It is quite possible that the required bandwidth for SL-PRS may be 10 MHz, 20 MHz, or even more, especially in higher frequency bands. With regard to the SL Positioning resource allocation, RAN1 will study further Option 1: Dedicated resource pool for SL-PRS and Option 2: Shared resource pool with sidelink communication (i.e., PSCCH/PSSCH and/or PSFCH). Shared resource pool with sidelink communication means that SL-PRS transmission(s) are multiplexed in sidelink resource pool with PSCCH/PSSCH resources (e.g., in NR Release 16/17/18 sidelink resource pool).

Moreover, sidelink control information may be provided by the TX UE for scheduling/indicating/allocating SL-PRS resources, in order to let the Receiving (RX) UE know where/when to receive/measure corresponding SL-PRS. The sidelink control information for scheduling/indicating/allocating SL-PRS resources may be multiplexed/transmitted in the dedicated resource pool for SL-PRS of option 1, or be transmitted on PSCCH in the shared sidelink resource pool of option 2.

Furthermore, given the larger bandwidth requirement of SL-PRS, Comb-N SL-PRS design can be supported for providing more available SL-PRS resources, and a configured/adjusted symbol number can be supported as one SL-PRS occasion. The potential candidate value of N may be 1, 2, 4, 6, 8, or 12. According to RAN1 #109-e, there are at least some possible designs of SL-PRS pattern, given M symbol and comb-N:
Fully staggered SL-PRS pattern, M=N, and at each symbol a different Resource Element (RE) offset is used; and/or
Partially staggered SL-PRS pattern, M<N, at each symbol a different RE offset is used; and/or
Unstaggered SL-PRS patterns, N>1, at each symbol a same RE offset is used.

Preferably in certain embodiments, for comb-N SL-PRS design/structure, possible frequency/comb/RE offsets may be 0 to (N−1).

According to RAN1 #110, scheme 1 and scheme 2 are introduced for SL-PRS resource allocation.
Scheme 1: Network-centric operation SL-PRS resource allocation (e.g., similar to a legacy Mode 1 solution).
   The network (e.g., gNodeB (gNB), Location Management Function (LMF), gNB & LMF) allocates resources for SL-PRS.
Scheme 2: UE autonomous SL-PRS resource allocation (e.g., similar to legacy Mode 2 solution).
   At least one of the UE(s) participating in the sidelink positioning operation allocates resources for SL-PRS.

For scheme 2, if the concept of legacy NR Mode 2 is applied, the UE may perform sensing on SL-PRS resources in sensing duration, and then exclude candidate SL-PRS resources based on a sensing result. After the exclusion step, the UE may determine valid candidate SL-PRS resources and then randomly select some candidate SL-PRS resource(s) from that.

For scheme 1, the network node may transmit an SL grant for scheduling SL-PRS resource(s). There are some methods for designing the SL grant, e.g., (1) define extra fields in DCI format 30 (i.e., current sidelink grant for scheduling PSSCH resources) to load SL-PRS resource information, or (2) define a new DCI format exclusively for including SL-PRS resource information, wherein the new DCI format is with Cyclic Redundancy Check (CRC) scrambled by ‘SL-PRS-Radio Network Temporary Identifier (RNTI)’. Other DCI format designs are also possible for the SL grant for SL-PRS resource information. The SL-PRS resource information in either DCI format design (1) or (2), or other DCI format design, may include any of the resource pool index for SL-PRS transmission, SL-PRS resource timing (e.g., which sidelink slot(s)), periodicity, and/or time offset, comb pattern, frequency offset (in unit of RE), sub-channel index(es)/number, number of symbols, SL-PRS occasion, etc.

However, there are some difference between scheme 1 for SL-PRS and mode 1 for sidelink data/PSSCH. For an instance, in mode 1, the network node may transmit sidelink grant(s) for scheduling PSSCH/PSCCH resources to the TX UE, based on SL-BSR from the TX UE. The TX UE may transmit SL-BSR MAC CE for comprising/transmitting the SL buffer status report. However, SL-BSR can only comprise information (e.g., buffer size, total amount of data) of the available sidelink data associated with/from sidelink logical channel(s). Thus, there is an issue with how the network node determines the scheduling of SL-PRS resources for the TX UE.

To deal with above issues on SL-PRS scheme 1, various concepts, mechanisms, methods, and/or embodiments are provided in the following disclosure.

### Concept A

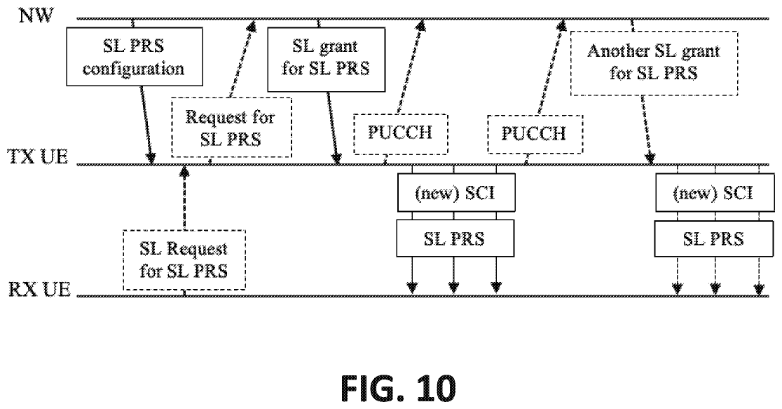

For scheme 1, some combination(s) of following steps/behaviors/procedures/operations may be performed for SL-PRS. For example, FIG. 10 shows a possible instance.
The TX UE may receive SL-PRS (related) configuration, from the network node, for operating in scheme 1. The SL-PRS (related) configuration may be/comprise any of scheme 1 related configuration, configuration for dedicated or common/shared resource pool for SL-PRS, configuration for configured grant type 1 for SL-PRS, configuration for configured grant type 2 for SL-PRS, periodic SL-PRS configuration, semi-persistent SL-PRS configuration, one or more SR configurations for SL-PRS, or etc.

Preferably in certain embodiments, (part of) the aforementioned relevant information or configuration(s) for SL-PRS may be carried/broadcasted by system information or transmitted by at least one dedicated Radio Resource Control (RRC) message specific to the TX UE. The TX UE may use these two ways (i.e., broadcast or dedicated) at different timings. (Part of) the aforementioned relevant information or configuration(s) for SL-PRS may be associated with one or more (positioning/ranging) services (type), aforementioned scheme type, one or more QoSs, one or more positioning/ranging methods, one or more destination/peer UEs, or destination/source (Layer 2) Identities (ID(s)). Preferably in certain embodiments, the TX UE may use different scheme types simultaneously for different SL-PRS patterns/configurations/triggers/requests (on different resource pools).
The TX UE may receive an SL request/trigger for SL-PRS from the RX UE. The SL request/trigger for SL-PRS may be transmitted via sidelink or PC5 interface. Preferably in certain embodiments, the SL request/trigger for SL-PRS may comprise information/patterns or requirements of SL-PRS, e.g., any of (required) SL-PRS bandwidth, priority, periodicity, periodicity change, one shot or multiple shots, comb size N, number M of SL-PRS symbols, latency (requirement) of SL-PRS/positioning/range, coverage/distance (requirement) of SL-PRS/positioning/range, accuracy (requirement) of SL-PRS/positioning/range, power (requirement) of SL-PRS/positioning/range, SL-PRS activation request/trigger, or SL-PRS deactivation/release request/trigger.
For acquiring SL-PRS resources (e.g., when the TX UE does not have available SL-PRS resource(s) for performing triggered/requested SL-PRS transmission(s)), the TX UE may transmit, to the network node, a request for SL-PRS. The request for SL-PRS may be transmitted via uplink or Uu interface. Preferably in certain embodiments, the TX UE may (trigger to) transmit the request for SL-PRS, in response to the SL request/trigger for SL-PRS from the RX UE. Preferably and/or alternatively, the TX UE may (trigger to) transmit the request for SL-PRS, in response to some triggering condition(s)/event(s). Preferably and/or alternatively, the TX UE may (trigger to) transmit the request for SL-PRS based on the trigger/request from the higher layer of the TX UE (e.g., application layer, positioning/ranging layer, SL positioning protocol layer, RRC layer, MAC layer). Preferably in certain embodiments, the trigger/request from the higher layer of the TX UE for SL-PRS may comprise information/pattern or requirement of SL-PRS, e.g., any of (required) SL-PRS bandwidth, priority, periodicity, periodicity change, one shot or multiple shots, comb size N, number M of SL-PRS symbols, destination (layer-1 or layer-2) ID, latency (requirement) of SL-PRS/positioning/range, coverage/distance (requirement) of SL-PRS/positioning/range, accuracy (requirement) of SL-PRS/positioning/range, power (requirement) of SL-PRS/positioning/range, SL-PRS activation request/trigger, or SL-PRS deactivation/release request/trigger.

In one method, the request for SL-PRS may be/comprise SR for SL-PRS. The TX UE may transmit the SR for SL-PRS on a PUCCH resource. The PUCCH resource or the SR resource for SL-PRS may be configured/provided by the network node.
In one embodiment, the TX UE may be configured/provided, by the network node, with one SR configuration for SL-PRS (e.g., one SR configuration for SL-PRS for all sidelink or PC5-RRC connections of the TX UE). The TX UE may determine/derive the PUCCH resource or the SR resource for SL-PRS based on the one SR configuration. The one SR configuration could be indicated via a parameter or an information element in an RRC message (e.g., sl-PRS-SchedulingRequestId). The one SR configuration could be shared with SL/UL logical channel(s) or with SL/UL MAC CE(s). Alternatively and/or additionally, the one SR configuration may be dedicated for SL-PRS. The network may not configure a same SR configuration for SL-PRS and for a logical channel (and/or a MAC CE).
In one embodiment, the TX UE may be configured/provided, by the network node, with one or more SR configurations for SL-PRS. (Each of) The one or more SR configurations for SL-PRS may be associated with different information/pattern or requirement of SL-PRS, e.g., any of (required) SL-PRS bandwidth, priority, periodicity, periodicity change, one shot or multiple shots, comb size N, number M of SL-PRS symbols, latency (requirement) of SL-PRS/positioning/range, coverage/distance (requirement) of SL-PRS/positioning/range, accuracy (requirement) of SL-PRS/positioning/range, power (requirement) of SL-PRS/positioning/range, resource pool for SL-PRS, carrier for SL-PRS, SL-PRS activation request/trigger, or SL-PRS deactivation/release request/trigger. Preferably in certain embodiments, the SR or PUCCH resource may further indicate, be associated with, identify, or include different requirement/type/pattern information for SL-PRS so that the network could allocate adequate SL grant/resource to the TX UE for sending (different) SL-PRS. The TX UE may determine/derive the PUCCH resource or the SR resource for SL-PRS based on a first SR configuration among the one or more SR configurations for SL-PRS. The TX UE may determine/derive the first SR configuration, based on information/pattern or requirement of SL-PRS associated with the SL request/trigger for SL-PRS from the RX UE, the triggering condition(s)/event(s), or the trigger/request from the higher layer of the TX UE. The TX UE may determine/derive the first SR configuration, based on the SL request/trigger for SL-PRS from the RX UE, the triggering condition(s)/event(s), or the trigger/request from the higher layer of the TX UE.

In one method, the request for SL-PRS may be/comprise a MAC CE for SL-PRS. The MAC CE for SL-PRS may comprise information/pattern or requirement of SL-PRS, e.g., any of (required) SL-PRS bandwidth, priority, periodicity, periodicity change, one shot or multiple shots, comb size N, number M of SL-PRS symbols, destination (layer-1 or layer-2) ID, latency (requirement) of SL-PRS/positioning/range, coverage/distance (requirement) of SL-PRS/positioning/range, accuracy (requirement) of SL-PRS/positioning/range, power (requirement) of SL-PRS/positioning/range, resource pool for SL-PRS, carrier for SL-PRS, SL-PRS activation request/trigger, or SL-PRS deactivation/release request/trigger. Preferably and/or alternatively, the MAC CE for SL-PRS may comprise information or requirements of one or more (preferred) resource pools for SL-PRS. Preferably in certain embodiments, the MAC CE for SL-PRS could comprise at least a bit-map, and preferably each bit of the bit-map is associated with one resource pool for SL-PRS among a plurality of resource pools (configured) for SL-PRS. Preferably in certain embodiments, the size of the bit-map may be based on a number of (configured) resource pools for SL-PRS. Preferably in certain embodiments, each resource pool for SL-PRS may associate with different requirements of SL-PRS. Preferably in certain embodiments, the association between bit-map and the plurality of resource pools for SL-PRS is one-to-one mapping. Preferably in certain embodiments, ascending order of the resource pool index would be associated with the ascending order of each bit of the bit-map. Preferably in certain embodiments, the MAC CE may comprise information of carrier index for one or more resource pools for SL-PRS (when/if resource pool indexing is reused for a different carrier). Preferably in certain embodiments, the MAC CE does not comprise information of carrier index for one or more resource pools for SL-PRS (when/if resource pool indexing is jointly indexing for different carrier). Preferably in certain embodiments, different requirements of SL-PRS may associate with a different priority (value). Preferably in certain embodiments, the MAC CE for SL-PRS may not be SL-BSR MAC CE. The TX UE may transmit either or both of the MAC CE for SL-PRS and/or the SL-BSR MAC CE (in one MAC PDU) to the network node. Preferably in certain embodiments, multiplexing order (to be included in one MAC PDU to the network node) for/between the MAC CE for SL-PRS and the SL-BSR MAC CE would be MAC CE for SL-PRS over SL-BSR MAC CE. Preferably in certain embodiments, when the size of one MAC PDU (to be transmitted to network node) cannot accommodate both MAC CE for SL-PRS and SL-BSR MAC CE, the MAC CE for SL-PRS would be included (and/or SL-BSR MAC CE may not be included). Alternatively, the multiplexing order (to be included in one MAC PDU to the network node) for the MAC CE for SL-PRS and SL-BSR MAC CE would be SL-BSR MAC CE over MAC CE for SL-PRS. Preferably in certain embodiments, when the size of MAC PDU (to be transmitted to network node) cannot accommodate both MAC CE for SL-PRS and SL-BSR MAC CE, the SL-BSR MAC CE would be included (and/or MAC CE for SL-PRS may not be included). Preferably in certain embodiments, the multiplexing order (to be included in one MAC PDU to the network node) may be based on priority of SL data traffic (or logical channel) associated with the SL-BSR MAC CE. Preferably in certain embodiments, the multiplexing order (to be included in one MAC PDU to the network node) may be based on a priority or requirement of SL-PRS (associated with MAC CE for SL-PRS). Preferably in certain embodiments, the multiplexing order (to be included in one MAC PDU to the network node) may be based on (priority or requirement of) the request of SL-PRS. Preferably in certain embodiments, the multiplexing order (to be included in one MAC PDU to the network node) may be based on one or more thresholds. Preferably in certain embodiments, the one or more thresholds may comprise a first and/or a second threshold. Preferably in certain embodiments, when SL data traffic's priority is larger than the first threshold (and no matter/regardless of priority of SL-PRS being larger than or equal to or smaller than the second threshold), the SL-BSR MAC CE (associated with the data traffic) is prioritized over MAC CE for SL-PRS. Preferably in certain embodiments, when the SL data traffic's priority is smaller than the first threshold (and no matter/regardless of priority of SL-PRS being larger than or equal to or smaller than the second threshold), the MAC CE for SL-PRS is prioritized over SL-BSR MAC CE (associated with the data traffic). Preferably in certain embodiments, when the SL data traffic's priority is smaller than the first threshold and priority of SL-PRS being larger than or equal to the second threshold, MAC CE for SL-PRS is prioritized over SL-BSR MAC CE (associated with the SL data traffic). Preferably and/or alternatively, the MAC CE (for SL-PRS) may be (an extended or an enhanced) SL-BSR MAC CE. The SL-BSR MAC CE may comprise either or both of the information/patterns or requirements of SL-PRS and/or the information (e.g., buffer size, total amount of data) of the available sidelink data associated with/from the sidelink logical channel(s). Preferably in certain embodiments, the SL-PRS may be associated with one or more sidelink logical channels. Some of the information or requirement of SL-PRS may be configured for the one or more sidelink logical channels. Different requirements of SL-PRS may be associated with different sidelink logical channels. The UE could trigger a SR for the MAC CE for SL-PRS if or when there are no UL resources available for transmitting the MAC CE. The SR could be associated with the highest priority logical channel reported/associated with the MAC CE and/or associated with (highest priority of) the SL-PRS reported/associated with the MAC CE.
The network node may transmit a sidelink grant for scheduling SL-PRS resources to the TX UE. Preferably in certain embodiments, the network node may transmit the sidelink grant for scheduling SL-PRS resources to the TX UE, in response to the request for SL-PRS from the TX UE. The sidelink grant for scheduling SL-PRS resources may schedule/allocate/indicate one or more SL-PRS resources/occasions in one sidelink resource pool (for SL-PRS). Preferably in certain embodiments, the sidelink grant for scheduling SL-PRS resources may be a DCI format for scheduling SL-PRS. The DCI format may be DCI format 3_0 with extra fields for SL-PRS resource information, or a new DCI format for SL-PRS resource information. The DCI format may be DCI format 3_0 with a resource pool indicator indicating resource pool for SL-PRS. The DCI format may be with CRC scrambled by SL-PRS-RNTI.
The TX UE may perform one or more SL-PRS transmissions on the one or more SL-PRS resources/occasions, based on the sidelink grant for scheduling SL-PRS resources. The TX UE may transmit one or more SCI for scheduling/indicate/allocate the one or more SL-PRS resources/occasions. Preferably in certain embodiments, for performing one SL-PRS transmission, the TX UE may transmit one SCI for scheduling/indicating/allocating at least the one SL-PRS transmission. Preferably in certain embodiments, the TX UE may transmit the one SCI and the one SL-PRS transmission in the same sidelink slot. Preferably in certain embodiments, the one SCI and the one SL-PRS transmission may be TDMed in separate symbol(s). Preferably in certain embodiments, Demodulation Reference Signal (DMRS) for PSCCH (carrying/delivering the one SCI) and the one SL-PRS transmission would be TDMed in separate symbol(s). Preferably in certain embodiments, the sidelink grant for scheduling SL-PRS resources may be valid for a specific/indicated/(pre)-configured period and the TX UE may continue sending SL-PRS within the period (based on or not based on the RX UE's feedback). Preferably in certain embodiments, the sidelink grant for scheduling SL-PRS resources may be valid for a specific/indicated/(pre)-configured period and the TX UE may (allow to) send/transmit SL-PRS within the period (based on or not based on the RX UE's feedback). The period information may be indicated in the sidelink grant or configured by (broadcast) system information or the higher layer (e.g., RRC dedicated message). Preferably in certain embodiments, the specific/indicated/(pre)-configured period may be/mean/replace/change/represent as a specific/indicated/(pre)-configured time duration.
Since SL-PRS transmission may not be encoded with channel coding, Hybrid Automatic Repeat Request (HARQ) combining may not be supported/performed for SL-PRS transmissions/reception. The RX UE may not decode SL-PRS via combing multiple SL-PRS transmissions/receptions. RX UE may perform sensing/detection or timing, angle, phase, or power measurement for SL-PRS transmission.

In one embodiment, SL HARQ-Acknowledgment (ACK) feedback and PSFCH may not be supported/applied/enabled for SL-PRS transmission. The RX UE may not transmit SL HARQ-ACK feedback or PSFCH, to indicate/request SL-PRS retransmission from the TX UE. If/when the RX UE requires more SL-PRS retransmissions from the TX UE, the RX UE may (trigger/request to) transmit another SL request/trigger for SL-PRS to the TX UE.

Preferably in certain embodiments, for the one or more SL-PRS transmissions, the TX UE may not transmit ACK/Negative Acknowledgment (NACK) on a PUCCH transmission/resource. The sidelink grant for scheduling SL-PRS resources or the DCI format for scheduling SL-PRS may not indicate PUCCH resource. The sidelink grant for scheduling SL-PRS resources or the DCI format for scheduling SL-PRS may not comprise a “PUCCH resource indicator” field and a “PSFCH-to-HARQ feedback timing indicator” field.

The TX UE may exclude or not be able/allowed to perform (some or all of) the one or more SL-PRS transmissions due to half-duplex restriction, UL-SL prioritization (e.g., timely overlapped UL transmission(s) is prioritized), RX/TX prioritization (e.g., timely overlapped SL reception (s) is prioritized), or Channel Busy Ratio (CBR) restriction.

Preferably in certain embodiments, any one or any combination of the above bullets for steps/behaviors/procedures/operations in scheme 1 for SL-PRS could be replaced by or reused by scheme 2 for SL-PRS (e.g., without the network's scheduling or activating or configuring for SL-PRS resource). Preferably in certain embodiments, one or more SL-PRS transmissions and/or resources for SL-PRS transmission could be based on the TX UE's sensing (instead of from the sidelink grant). Preferably in certain embodiments, one or more SL-PRS transmissions and/or resources for SL-PRS transmission could be based on the RX UE's scheduling (instead of from the sidelink grant). Preferably in certain embodiments, the SL request/trigger for SL-PRS (from the RX UE) would be transmitted in a different sidelink resource pool than the sidelink resource pool for SL-PRS. Preferably in certain embodiments, the SL request/trigger for SL-PRS (received in resource pool 1) may cross-pool schedule resources for SL-PRS in resource pool 2. Preferably in certain embodiments, resource pool 1 refers to the resource pool for communication and resource pool 2 refers to the resource pool for SL-PRS. Preferably in certain embodiments, resource pool 1 and resource pool 2 may be in a same or different SL Bandwidth Part (BWP). Preferably in certain embodiments, resource pool 1 and resource pool 2 may be in a same or different SL carrier. Preferably in certain embodiments, PSCCH and SL-PRS would be multiplexed in resource pool 2 (even if there is cross-pool scheduling from a request/trigger for SL-PRS in resource pool 1).

Preferably in certain embodiments, the sidelink grant for scheduling SL-PRS resources or the DCI format for scheduling SL-PRS may schedule/allocate/indicate the one or more SL-PRS resources/occasions without periodicity or periodicity as zero.

Preferably in certain embodiments, the sidelink grant for scheduling SL-PRS resources or the DCI format for scheduling SL-PRS may schedule/allocate/indicate the one or more SL-PRS resources/occasions with periodicity or periodicity as non-zero. Preferably in certain embodiments, the sidelink grant for scheduling SL-PRS resources or the DCI format for scheduling SL-PRS may be activation grant/DCI of the one or more SL resources/occasions with the periodicity. Preferably in certain embodiments, the sidelink grant for scheduling SL-PRS resources or the DCI format for scheduling SL-PRS may indicate information of the periodicity. Preferably in certain embodiments, the sidelink grant for scheduling SL-PRS resources or the DCI format for scheduling SL-PRS may indicate information of one SL-PRS configuration, wherein the SL-PRS configuration comprises the periodicity.

Preferably in certain embodiments, the sidelink grant for scheduling SL-PRS resources or the DCI format for scheduling SL-PRS may be a release or deactivation grant/DCI of the one or more SL resources/occasions with the periodicity. The one or more SL resources/occasions with the periodicity may be activated via an earlier activation grant/DCI of the one or more SL resources/occasions with the periodicity.

### Concept B

As described in Concept A, when the TX UE does not have available SL-PRS resource(s) for performing triggered/requested SL-PRS transmission(s), the TX UE may transmit, to the network node, a request for SL-PRS. Considering the TX UE may have one or more SL positioning/ranging-related services, the TX UE may require one or more SL-PRS resources with a same or different SL-PRS information/patterns or requirements. For acquiring the one or more SL-PRS resources with a same or different SL-PRS information/patterns or requirements, the TX UE may trigger or trigger to transmit, to the network node, one or more requests for SL-PRS.

Preferably in certain embodiments, the TX UE may have one or more SL-PRS triggering/requesting (which also could be referred to as triggers/requests herein) for performing one or more SL-PRS transmissions. Preferably in certain embodiments, a/each SL-PRS triggering/requesting may be in response to any of the received SL requests/triggers for SL-PRS, triggering condition(s)/event(s), or triggers/requests from the higher layer of the TX UE. Preferably in certain embodiments, a/each SL-PRS triggering/requesting may be associated with its information/pattern or requirement of SL-PRS, e.g., any of the (required) SL-PRS bandwidths, priority, periodicity, periodicity change, one shot or multiple shots, comb size N, number M of SL-PRS symbols, destination (layer-1 or layer-2) ID, latency (requirement) of SL-PRS/positioning/range, coverage/distance (requirement) of SL-PRS/positioning/range, accuracy (requirement) of SL-PRS/positioning/range, power (requirement) of SL-PRS/positioning/range, SL-PRS activation request/trigger, or SL-PRS deactivation/release request/trigger.

Preferably in certain embodiments, for one SL-PRS triggering/requesting, when the TX UE does not have available SL-PRS resource(s) for performing triggered/requested SL-PRS transmission(s), the TX UE may trigger to transmit, to the network node, a (resource) request for SL-PRS. Preferably in certain embodiments, for one or more SL-PRS triggering/requesting, when the TX UE does not have available SL-PRS resource(s) for performing the triggered/requested SL-PRS transmission(s), the TX UE may trigger to transmit, to the network node, one or more requests for SL-PRS.

Preferably in certain embodiments, a triggered and not yet transmitted request for SL-PRS may be noted/called/said as a pending request for SL-PRS. Preferably and/or alternatively, a triggered (may be transmitted) and not yet canceled/discarded request for SL-PRS may be noted/called/said as a pending request for SL-PRS.

Preferably in certain embodiments, a pending SL-PRS triggering/requesting may mean that the TX UE does not yet perform SL-PRS transmission(s) for the pending SL-PRS triggering/requesting or may mean the SL-PRS triggering/requesting is triggered but not yet canceled. When the TX UE performs SL-PRS transmission(s) for the pending SL-PRS triggering/requesting, the TX UE may cancel or discard the pending SL-PRS triggering/requesting.

The concept B is that when the TX UE has one or more pending requests for SL-PRS, and when the TX UE receives a sidelink grant for scheduling SL-PRS resources, the TX UE may need to update or drop or cancel (some of) the one or more pending requests for SL-PRS. Otherwise, the original one or more pending requests for SL-PRS may request, from the network node, unnecessary SL-PRS resources to the TX UE, which may induce resource waste and reduce resource utilization efficiency.

Additionally and/or alternatively, the UE could cancel the pending SR/PUCCH transmission for SL-PRS when or if a MAC PDU is transmitted and the MAC PDU includes a MAC CE for SL-PRS. The MAC CE for SL-PRS could indicate or comprise information/patterns or requirements of SL-PRS associated with the pending SR/PUCCH transmission. The pending SR/PUCCH transmission could be triggered prior to assembly of the MAC PDU or prior to transmission of the MAC PDU.

In one embodiment, the request for SL-PRS may be/comprise a MAC CE for SL-PRS. Preferably in certain embodiments, for one SL-PRS triggering/requesting, when the TX UE does not yet perform SL-PRS transmission(s) for the one SL-PRS triggering/requesting, the TX UE may (trigger to) comprise the information/pattern or requirement of SL-PRS associated with the one SL-PRS triggering/requesting in the MAC CE for SL-PRS. Preferably in certain embodiments, for one or more SL-PRS triggering/requesting, when the TX UE does not yet perform SL-PRS transmission(s) for the one or more SL-PRS triggering/requesting, the TX UE may (trigger to) comprise one or more information/patterns or requirements of SL-PRS associated with the one or more SL-PRS triggering/requesting in the MAC CE for SL-PRS.

Preferably in certain embodiments, the TX UE may generate a first MAC CE for SL-PRS, wherein the first MAC CE for SL-PRS comprises first one or more information/patterns or requirements of SL-PRS associated with the first one or more pending SL-PRS triggering/requesting. Preferably in certain embodiments, the TX UE may perform a first UL transmission for transmitting/comprising the first MAC CE for SL-PRS. Preferably in certain embodiments, there may be a time duration after generation of the first MAC CE for SL-PRS and before the first UL transmission for transmitting/comprising the first MAC CE for SL-PRS.

Preferably in certain embodiments, when the TX UE receives a sidelink grant for scheduling (available) SL-PRS resources within the time duration or before transmitting the first MAC CE for SL-PRS, the TX UE may cancel or discard the first MAC CE for SL-PRS and generate a second MAC CE for SL-PRS. The TX UE may generate the second MAC CE for SL-PRS, wherein the second MAC CE for SL-PRS comprises second one or more information/patterns or requirements of SL-PRS associated with the second one or more pending SL-PRS triggering/requesting. Preferably in certain embodiments, the second one or more pending SL-PRS triggering/requesting excludes a specific pending SL-PRS triggering/requesting among the first one or more pending SL-PRS triggering/requesting. Preferably in certain embodiments, the second one or more information/patterns or requirements of SL-PRS excludes a specific information/pattern or requirement of SL-PRS among the first one or more information/patterns or requirements of SL-PRS. The specific information/pattern or requirement of SL-PRS is associated with the specific pending SL-PRS triggering/requesting. Preferably in certain embodiments, the second one or more pending SL-PRS triggering/requesting may not exclude pending SL-PRS triggering/requesting other than the specific pending SL-PRS triggering/requesting, among the first one or more pending SL-PRS triggering/requesting. Preferably in certain embodiments, the second one or more information/patterns or requirements of SL-PRS may not exclude information/pattern or requirement of SL-PRS other than the specific information/pattern or requirement of SL-PRS, among the first one or more information/patterns or requirements of SL-PRS. The specific information/pattern or requirement of SL-PRS is associated with the specific pending SL-PRS triggering/requesting.

Preferably and/or alternatively, when the TX UE receives a sidelink grant for scheduling (available) SL-PRS resources within the time duration or before transmitting the MAC CE for SL-PRS, the TX UE may update/regenerate the first MAC CE for SL-PRS. The updated/regenerated first MAC CE for SL-PRS comprises the second one or more information/patterns or requirements of SL-PRS associated with the second one or more pending SL-PRS triggering/requesting. Preferably in certain embodiments, the second one or more pending SL-PRS triggering/requesting excludes a specific pending SL-PRS triggering/requesting among the first one or more pending SL-PRS triggering/requesting. Preferably in certain embodiments, the second one or more information/patterns or requirements of SL-PRS excludes a specific information/pattern or requirement of SL-PRS among the first one or more information/patterns or requirements of SL-PRS. Preferably in certain embodiments, the second one or more pending SL-PRS triggering/requesting may not exclude pending SL-PRS triggering/requesting other than the specific pending SL-PRS triggering/requesting, among the first one or more pending SL-PRS triggering/requesting. Preferably in certain embodiments, the second one or more information/patterns or requirements of SL-PRS may not exclude information/pattern or requirement of SL-PRS other than the specific information/pattern or requirement of SL-PRS, among the first one or more information/patterns or requirements of SL-PRS. The specific information/pattern or requirement of SL-PRS is associated with the specific pending SL-PRS triggering/requesting. Preferably in certain embodiments, the updated/regenerated first MAC CE for SL-PRS excludes the specific information/pattern or requirement of SL-PRS from the first MAC CE for SL-PRS. Preferably in certain embodiments, the updated/regenerated first MAC CE for SL-PRS may not exclude information/pattern or requirement of SL-PRS other than the specific information/pattern or requirement of SL-PRS from the first MAC CE for SL-PRS.

Preferably in certain embodiments, the TX UE may perform at least a SL-PRS transmission on one of the scheduled (available) SL-PRS resources. Preferably in certain embodiments, the TX UE may cancel or discard the first MAC CE for SL-PRS and generate the second MAC CE for SL-PRS in response to the SL-PRS transmission or after performing the SL-PRS transmission (e.g., the first/initial SL-PRS transmission on the first/initial scheduled SL-PRS resource or the last/latest SL-PRS transmission on the last/latest SL-PRS resource among the scheduled SL-PRS resources). Preferably in certain embodiments, the TX UE may update/regenerate the first MAC CE for SL-PRS in response to the SL-PRS transmission or after performing the SL-PRS transmission (e.g., the first/initial SL-PRS transmission on the first/initial scheduled SL-PRS resource or the last/latest SL-PRS transmission on the last/latest SL-PRS resource among the scheduled SL-PRS resources). Preferably in certain embodiments, the TX UE may cancel or discard the specific pending SL-PRS triggering/requesting in response to the SL-PRS transmission or after performing the SL-PRS transmission. Preferably in certain embodiments, the TX UE may not cancel or discard pending SL-PRS triggering/requesting other than the specific pending SL-PRS triggering/requesting, in response to the sidelink grant or the scheduled (available) SL-PRS resources or the SL-PRS transmission.

Preferably in certain embodiments, the specific information/pattern or requirement of SL-PRS or the specific pending SL-PRS triggering/requesting may be derived/determined based on the characteristic(s) of the scheduled (available) SL-PRS resources. Preferably in certain embodiments, the characteristic(s) of the scheduled (available) SL-PRS resources may mean/comprise any of SL-PRS resource bandwidth, priority, periodicity, one or multiple SL-PRS resources, comb size N, number M of SL-PRS symbols, time gap between the SL-PRS resources, power setting/adjustment of the SL-PRS transmission, SL-PRS activation request/trigger, or SL-PRS deactivation/release request/trigger.

Preferably in certain embodiments, the specific information/pattern or requirement of SL-PRS or the specific pending SL-PRS triggering/requesting may be derived/determined based on the characteristic(s) of the SL-PRS transmission (on the one of the scheduled (available) SL-PRS resources). Preferably in certain embodiments, the characteristic(s) of the SL-PRS transmission may mean/comprise any of source (layer-1 or layer-2) ID, destination (layer-1 or layer-2) ID, cast-type, SL-PRS resource bandwidth, priority, periodicity, one or multiple SL-PRS resources, comb size N, number M of SL-PRS symbols, time gap between the SL-PRS resources, power setting/adjustment of the SL-PRS transmission, SL-PRS activation request/trigger, or SL-PRS deactivation/release request/trigger.

Preferably in certain embodiments, the TX UE may determine/derive the specific information/pattern or requirement of SL-PRS or the specific pending SL-PRS triggering/requesting such that the characteristic(s) of the scheduled (available) SL-PRS resources or the SL-PRS transmission satisfy the specific information/pattern or requirement of SL-PRS (associated with the specific pending SL-PRS triggering/requesting). Preferably in certain embodiments, the TX UE may exclude the specific information/pattern or requirement of SL-PRS wherein the characteristic(s) of the scheduled (available) SL-PRS resources or the SL-PRS transmission satisfy the specific information/pattern or requirement of SL-PRS (associated with the specific pending SL-PRS triggering/requesting).

Preferably in certain embodiments, the TX UE may perform a second UL transmission for transmitting/comprising the second MAC CE for SL-PRS or the updated/regenerated first MAC CE for SL-PRS. Preferably in certain embodiments, the TX UE may not perform the first UL transmission when the TX UE receives the sidelink grant for scheduling (available) SL-PRS resources within the time duration or before transmitting the first MAC CE for SL-PRS.

For instance, the TX UE has three SL-PRS triggering/requesting. Preferably in certain embodiments, the first SL-PRS triggering/requesting may be triggered/requested in response to a received SL request/trigger for SL-PRS from an RX UE1. The first SL-PRS triggering/requesting may be associated with a first destination ID associated with the RX UE1 and/or a cast-type as unicast. The first SL-PRS triggering/requesting may be associated with a priority P1 and/or a required SL-PRS bandwidth BW1. Preferably in certain embodiments, the second SL-PRS triggering/requesting may be triggered/requested in response to a trigger/request from the higher layer of the TX UE (e.g., on-demand SL-PRS in higher layer, need of UE position, TX UE position update). The second SL-PRS triggering/requesting may be associated with a second destination ID and/or a cast-type as broadcast. The second SL-PRS triggering/requesting may be associated with a priority P2 and/or a required SL-PRS bandwidth BW2. Preferably in certain embodiments, the third SL-PRS triggering/requesting may be triggered/requested in response to triggering condition(s)/event(s), e.g., need of SL-PRS retransmission or condition(s)/events in RRC/MAC. The third SL-PRS triggering/requesting may be associated with a third destination ID and/or a cast-type as groupcast. The third SL-PRS triggering/requesting may be associated with a priority P3 and/or a required SL-PRS bandwidth BW3.

In one example, the TX UE may generate a first MAC CE for SL-PRS. The first MAC CE for SL-PRS may comprise any of the priority P1, the required SL-PRS bandwidth BW1, the priority P2, the required SL-PRS bandwidth BW2, the priority P3 and/or the required SL-PRS bandwidth BW3. Before the TX UE transmits the first MAC CE for SL-PRS to network node, the TX UE may receive a SL grant for scheduling two SL-PRS resources and perform SL-PRS1 and SL-PRS2 transmission on the scheduled two SL-PRS resources respectively. Preferably in certain embodiments, the bandwidth of two SL-PRS resources may be larger than or equal to the BW3 and/or may be smaller than BW2 and BW1. The TX UE may determine to utilize the two SL-PRS resources for the third destination, and/or the TX UE may perform the SL-PRS1 and/or SL-PRS2 transmission to the third destination. Accordingly, the TX UE may update the first MAC CE or (drop/discard the first MAC CE and) generate a second MAC CE for SL-PRS. The updated first MAC CE or the second MAC CE may comprise any of the priority P1, the required SL-PRS bandwidth BW1, the priority P2, the required SL-PRS bandwidth BW2. The updated first MAC CE or the second MAC CE may exclude the priority P3 and/or the required SL-PRS bandwidth BW3. Preferably in certain embodiments, the bandwidth of two SL-PRS resources may be larger than or equal to the BW2 and BW1. The TX UE may determine to utilize the two SL-PRS resources for the second destination and the first destination, and/or the TX UE may perform the SL-PRS1 transmission for the first destination and perform the SL-PRS2 transmission to the second destination. Accordingly, the TX UE may update the first MAC CE or (drop/discard the first MAC CE and) generate a second MAC CE for SL-PRS. The updated first MAC CE or the second MAC CE may comprise any of the priority P3, the required SL-PRS bandwidth BW3. The updated first MAC CE or the second MAC CE may exclude the priority P1, the required SL-PRS bandwidth BW1, the priority P2 and/or the required SL-PRS bandwidth BW2.

According to [10] (3GPP TR 23.700-86 V1.2.0), the Ranging/Sidelink positioning supports the scheduled location time feature. That is, the scheduled location time may be used to get the Ranging/Sidelink positioning measurement data (i.e., SL-PRS measurements). According to [11](3GPP TS 23.273 V17.6.0), the scheduled location time could be at the time point(s) equals to T+(N−1)*P, where T is the initial Scheduled Location Time (i.e., the very first time for SL-PRS measurement), N is the Report Number (i.e., how many SL-PRS measurements to be performed, N>1) and P is the time interval between successive periodic events (i.e., time interval between two successive SL-PRS measurements). That is, the SL-PRS measurements could be performed periodically. Thus, in case the TX UE performs Scheme 1, in order to assist the network to (periodically) allocate SL-PRS resources for the SL-PRS transmissions/measurements, the TX UE may provide at least one of initial Scheduled Location Time, Report Number, time interval between successive periodic SL-PRS measurements and etc. (in addition to those parameters related to SL-PRS resource allocation/determination as mentioned above) to the network via e.g., RRC message, SL Positioning Protocol (SLPP) layer message, Non-Access Stratum (NAS) layer message or upper layer message. Alternatively, since the SL-PRS measurements are performed by the RX UE, it is also feasible for the RX UE to provide at least one of initial Scheduled Location Time, Report Number, time interval between successive periodic SL-PRS measurements and etc. to the network via e.g., RRC message, SLPP layer message, NAS layer message or upper layer message. In this way, when it is close to the scheduled location time, the network (autonomously) could allocate or schedule the TX UE with SL-PRS resources for performing SL-PRS transmissions. The network could make sure that the RX UE could perform the SL-PRS measurements in/before the scheduled location time when preparing the SL-PRS resources for the TX UE.

On the other hand, in case the TX UE performs Scheme 2, in order to assist the TX UE to (periodically) select SL-PRS resources for the SL-PRS measurements, the RX UE could provide at least one of initial Scheduled Location Time, Report Number, time interval between successive periodic SL-PRS measurements and etc. to the TX UE via e.g., PC5-RRC message, SLPP layer message, NAS layer message or upper layer message. Similarly, the TX UE could make sure that the RX UE could perform the SL-PRS measurements in/before the scheduled location time when selecting the SL-PRS resources for SL-PRS transmissions.

More specifically, granularity or time units of the scheduled location time could be UTC time (containing e.g., date, hour, minute and/or second) or a timestamp.

Any of the methods, alternatives, steps, examples, and embodiments proposed and disclosed above and below may be applied independently, individually, and/or with multiple methods, alternatives, steps, examples, and embodiments combined together.

Preferably in certain embodiments, the TX UE may be a target UE. The RX UE may be a location UE or a reference UE or an anchor UE. Preferably in certain embodiments, the TX UE may be/mean a UE performing the SL-PRS transmission.

Preferably and/or alternatively, the RX UE may be a target UE. The TX UE may be a location UE or a reference UE or an anchor UE. Preferably in certain embodiments, the RX UE may be/mean a UE receiving/measuring the SL-PRS transmission.

Preferably in certain embodiments, the TX UE may be a server UE. Preferably and/or alternatively, the RX UE may be a server UE.

Preferably in certain embodiments, the SCI/PSCCH associated with SL-PRS may include/comprise information for scheduling/indicating/allocating SL-PRS resource. Preferably in certain embodiments, the SCI/PSCCH in the resource pool for SL-PRS may not comprise information for PSSCH/PSFCH. Preferably in certain embodiments, the SCI/PSCCH in the resource pool for SL-PRS may be different from another SCI/PSCCH in a resource pool with sidelink communication (i.e., PSSCH and/or PSFCH). Preferably in certain embodiments, the SCI/PSCCH associated with SL-PRS may be different from another SCI/PSCCH associated with PSSCH and/or PSFCH.

Preferably in certain embodiments, sidelink control information for PSSCH may be transmitted/delivered via 1st stage SCI and 2nd stage SCI. Preferably in certain embodiments, the sidelink control information for PSSCH may be delivered at least in PSCCH. Preferably in certain embodiments, the sidelink control information for PSSCH may comprise 1st stage SCI. Preferably in certain embodiments, the 1st stage SCI may be transmitted via PSCCH. Preferably in certain embodiments, the sidelink control information for PSSCH may comprise 2nd stage SCI. Preferably in certain embodiments, the 2nd stage SCI may be transmitted via multiplexing with PSSCH.

Preferably in certain embodiments, the SCI format 1 or SCI format 1-X is 1st stage SCI. Preferably in certain embodiments, the SCI format 2-A or 2-B or 2-C or 2-X is a 2nd stage SCI.

Preferably in certain embodiments, for transmitting PSSCH in a slot or subslot, the TX UE needs to transmit SCI in the slot or the subslot for scheduling the PSSCH.

Preferably in certain embodiments, the resource pool for SL-PRS may be a dedicated resource pool for SL-PRS. Preferably in certain embodiments, the resource pool for SL-PRS may be a dedicated resource pool for sidelink reference signal and/or sidelink control information.

Preferably in certain embodiments, the resource pool for SL-PRS may not be a resource pool with sidelink communication (i.e., PSCCH/PSSCH and/or PSFCH). Alternatively, the resource pool for SL-PRS may be a shared resource pool with sidelink communication. The resource pool for SL-PRS may comprise PSSCH and/or PSFCH resources.

Preferably in certain embodiments, the SL-PRS may be applied/utilized for (absolute and/or relative) positioning and/or ranging.

Preferably in certain embodiments, the SL-PRS may be applied/utilized for any of time-based positioning/ranging methods and/or angle-based positioning/ranging methods. Preferably in certain embodiments, the SL-PRS may be applied/utilized for any of TDoA, RTT-based positioning/ranging, AoA, AoD, or carrier phase measurement based positioning.

Preferably in certain embodiments, any of above methods, alternatives and embodiments for SL-PRS may be applied for another/other reference signal (e.g., reference signal designed/introduced in future 5G or 6G or etc.).

Preferably in certain embodiments, any of above methods, alternatives and embodiments for SL-PRS may be applied for SL CSI-RS (for beam management).

Preferably in certain embodiments, any of above methods, alternatives and embodiments for SL-PRS may be applied for reference signal for (High-Resolution) localization (e.g., reference signal designed/introduced in future 5G or 6G or etc.).

Preferably in certain embodiments, any of above methods, alternatives and embodiments for SL-PRS may be applied for reference signal for (High-Resolution) sensing (e.g., reference signal designed/introduced in future 5G or 6G or etc.).

Preferably in certain embodiments, any of above methods, alternatives and embodiments for SL-PRS may be applied for reference signal for (High-resolution) imaging (e.g., reference signal designed/introduced in future 5G or 6G or etc.).

Preferably in certain embodiments, the slot may mean a sidelink slot. Preferably in certain embodiments, the slot may be represented/replaced as a Transmission Time Interval (TTI).

Preferably in certain embodiments, the sidelink slot may mean slot for sidelink. Preferably in certain embodiments, a TTI may be a subframe (for sidelink) or slot (for sidelink) or subslot (for sidelink). Preferably in certain embodiments, a TTI comprises multiple symbols, e.g., 12 or 14 symbols. Preferably in certain embodiments, a TTI may be a slot (fully/partially) comprising sidelink symbols. Preferably in certain embodiments, a TTI may mean a transmission time interval for a sidelink (data) transmission. Preferably in certain embodiments, a sidelink slot or a slot for sidelink may contain all Orthogonal Frequency Division Multiplexing (OFDM) symbols available for sidelink transmission. Preferably in certain embodiments, a sidelink slot or a slot for sidelink may contain a consecutive number of symbols available for sidelink transmission. Preferably in certain embodiments, a sidelink slot or a slot for sidelink means that a slot is included/comprised in a sidelink resource pool.

Preferably in certain embodiments, the symbol may mean a symbol indicated/configured for sidelink.

Preferably in certain embodiments, the slot may mean/comprise sidelink slot associated with the (sidelink) resource pool. Preferably in certain embodiments, the slot may not mean/comprise a sidelink slot associated with other (sidelink) resource pool.

Preferably in certain embodiments, the contiguous/consecutive slots may mean contiguous sidelink slots in/for the (sidelink) resource pool.

Preferably in certain embodiments, the contiguous/consecutive slots may or may not be contiguous/consecutive in physical slots. It means that the contiguous/consecutive slots in the sidelink resource pool may be not contiguous/consecutive from the aspect of physical slots. Preferably in certain embodiments, the contiguous/consecutive slots may or may not be contiguous/consecutive in sidelink slots in/for a sidelink BWP or a sidelink carrier/cell. It means that the contiguous/consecutive slots in the (sidelink) resource pool may not be contiguous/consecutive from the aspect of sidelink slots in a sidelink BWP or a sidelink carrier/cell. Preferably in certain embodiments, there may be one or more (sidelink) resource pools in a sidelink BWP or a sidelink carrier/cell.

Preferably in certain embodiments, a sub-channel is a unit for sidelink resource allocation/scheduling (for PSSCH). Preferably in certain embodiments, a sub-channel may comprise multiple contiguous PRBs in frequency domain. Preferably in certain embodiments, the number of PRBs for each sub-channel may be (pre-)configured for a sidelink resource pool. Preferably in certain embodiments, a sidelink resource pool (pre-)configuration may indicate/configure the number of PRBs for each sub-channel. Preferably in certain embodiments, the number of PRBs for each sub-channel may be any of 10, 12, 15, 20, 25, 50, 75, 100. Preferably in certain embodiments, a sub-channel may be represented as a unit for sidelink resource allocation/scheduling. Preferably in certain embodiments, a sub-channel may mean a set of consecutive PRBs in frequency domain. Preferably in certain embodiments, a sub-channel may mean a set of consecutive resource elements in frequency domain.

Preferably in certain embodiments, the sidelink transmission/reception may be UE-to-UE transmission/reception. Preferably in certain embodiments, the sidelink transmission/reception may be device-to-device transmission/reception. Preferably in certain embodiments, the sidelink transmission/reception may be Vehicle-to-Everything (V2X) transmission/reception. Preferably in certain embodiments, the sidelink transmission/reception may be Pedestrian-to-Everything (P2X) transmission/reception. Preferably in certain embodiments, the sidelink transmission/reception may be on PC5 interface.

Preferably in certain embodiments, the PC5 interface may be wireless interface for communication between UE and UE or between device and device. Preferably in certain embodiments, the PC5 interface may be wireless interface for communication between UEs or between devices. Preferably in certain embodiments, the PC5 interface may be wireless interface for V2X or P2X communication. Preferably in certain embodiments, the Uu interface may be wireless interface for communication between network node and device. Preferably in certain embodiments, the Uu interface may be wireless interface for communication between network node and UE.

Preferably in certain embodiments, the TX UE may be/mean/comprise/replace a first device. Preferably in certain embodiments, the TX UE may be a vehicle UE. Preferably in certain embodiments, the TX UE may be a V2X UE. Preferably in certain embodiments, the TX UE may be a (UE-type) Roadside Unit (RSU).

Preferably in certain embodiments, the RX UE may be a second device. Preferably in certain embodiments, the RX UE may be a vehicle UE. Preferably in certain embodiments, the RX device may be a V2X UE. Preferably in certain embodiments, the RX UE may be a (UE-type) RSU.

Preferably in certain embodiments, the TX UE and the RX UE are different devices.

Preferably in certain embodiments, frequency offset could be replaced by comb-offset or RE offset (e.g., 0˜N−1).

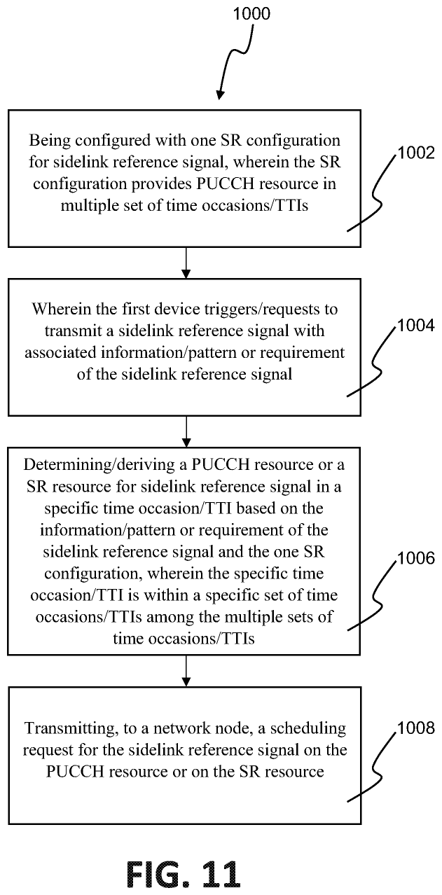

Referring to FIG. 11, with this and other concepts, systems, and methods of the present invention, a method 1000 for a first device in a wireless communication system comprises being configured with one SR configuration for sidelink reference signal, wherein the SR configuration provides PUCCH resource in multiple set of time occasions/TTIs (step 1002); wherein the first device triggers/requests to transmit a sidelink reference signal with associated information/pattern or requirement of the sidelink reference signal (step 1004); determining/deriving a PUCCH resource or a SR resource for sidelink reference signal in a specific time occasion/TTI based on the information/pattern or requirement of the sidelink reference signal and the one SR configuration, wherein the specific time occasion/TTI is within a specific set of time occasions/TTIs among the multiple sets of time occasions/TTIs (step 1006); and transmitting, to a network node, a scheduling request for the sidelink reference signal on the PUCCH resource or on the SR resource (step 1008).

In various embodiments, the method further comprises determining/deriving the specific time occasion/TTI or the specific set of time occasions/TTIs, based on the information/pattern or requirement of the sidelink reference signal, and/or the specific time occasion/TTI is the first/earliest time occasion/TTI within the specific set of time occasions/TTIs after the first device triggers/requests to transmit the sidelink reference signal and/or with a configured/processing time gap.

Referring back to FIGS. 3 and 4, in one or more embodiments from the perspective of a first device, the device 300 includes a program code 312 stored in memory 310 of the transmitter. The CPU 308 could execute program code 312 to: (i) be configured with one SR configuration for sidelink reference signal, wherein the SR configuration provides PUCCH resource in multiple set of time occasions/TTIs; (ii) wherein the first device triggers/requests to transmit a sidelink reference signal with associated information/pattern or requirement of the sidelink reference signal; (iii) determine/derive a PUCCH resource or a SR resource for sidelink reference signal in a specific time occasion/TTI based on the information/pattern or requirement of the sidelink reference signal and the one SR configuration, wherein the specific time occasion/TTI is within a specific set of time occasions/TTIs among the multiple sets of time occasions/TTIs; and (iv) transmit, to a network node, a scheduling request for the sidelink reference signal on the PUCCH resource or on the SR resource. Moreover, the CPU 308 can execute the program code 312 to perform all of the described actions, steps, and methods described above, below, or otherwise herein.

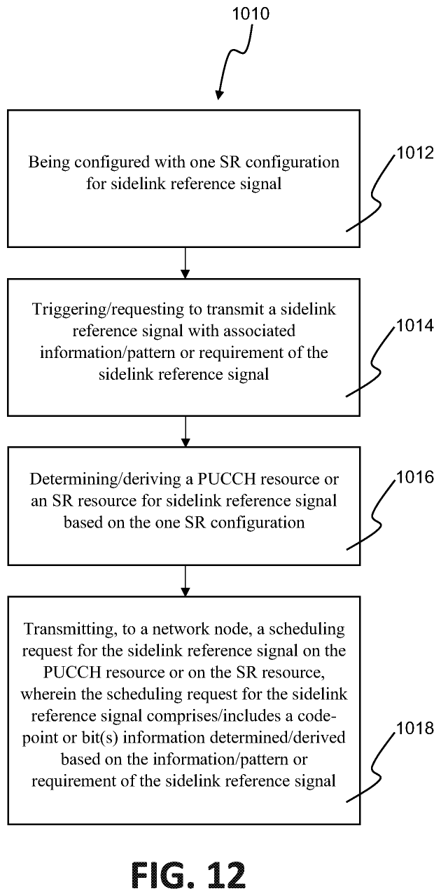

Referring to FIG. 12, with this and other concepts, systems, and methods of the present invention, a method 1010 for a first device in a wireless communication system comprises being configured with one SR configuration for sidelink reference signal (step 1012); triggering/requesting to transmit a sidelink reference signal with associated information/pattern or requirement of the sidelink reference signal (step 1014); determining/deriving a PUCCH resource or a SR resource for sidelink reference signal based on the one SR configuration (step 1016); and transmitting, to a network node, a scheduling request for the sidelink reference signal on the PUCCH resource or on the SR resource, wherein the scheduling request for the sidelink reference signal comprises/includes a code-point or bit(s) information determined/derived based on the information/pattern or requirement of the sidelink reference signal (step 1018).

In various embodiments, different code-point or bit(s) information are associated (respectively) with different information/pattern or requirement of sidelink reference signal.

Referring back to FIGS. 3 and 4, in one or more embodiments from the perspective of a first device, the device 300 includes a program code 312 stored in memory 310 of the transmitter. The CPU 308 could execute program code 312 to: (i) be configured with one SR configuration for sidelink reference signal; (ii) triggering/requesting to transmit a sidelink reference signal with associated information/pattern or requirement of the sidelink reference signal; (iii) determine/derive a PUCCH resource or a SR resource for sidelink reference signal based on the one SR configuration; and (iv) transmit, to a network node, a scheduling request for the sidelink reference signal on the PUCCH resource or on the SR resource, wherein the scheduling request for the sidelink reference signal comprises/includes a code-point or bit(s) information determined/derived based on the information/pattern or requirement of the sidelink reference signal. Moreover, the CPU 308 can execute the program code 312 to perform all of the described actions, steps, and methods described above, below, or otherwise herein.

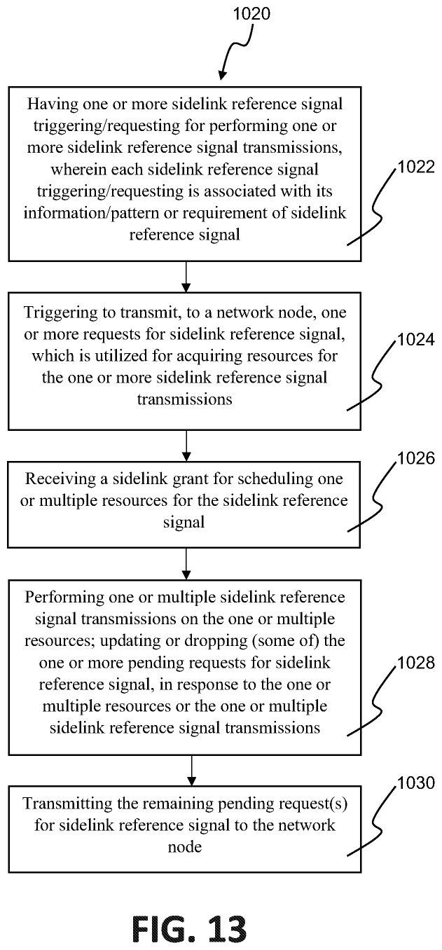

Referring to FIG. 13, with this and other concepts, systems, and methods of the present invention, a method 1020 for a first device in a wireless communication system comprises having one or more sidelink reference signal triggering/requesting for performing one or more sidelink reference signal transmissions, wherein each sidelink reference signal triggering/requesting is associated with its information/pattern or requirement of sidelink reference signal (step 1022); triggering to transmit, to a network node, one or more requests for sidelink reference signal, which is utilized for acquiring resources for the one or more sidelink reference signal transmissions (step 1024); receiving a sidelink grant for scheduling one or multiple resources for the sidelink reference signal (step 1026); performing one or multiple sidelink reference signal transmissions on the one or multiple resources; updating or dropping (some of) the one or more pending requests for sidelink reference signal, in response to the one or multiple resources or the one or multiple sidelink reference signal transmissions (step 1028); and transmitting the remaining pending request(s) for sidelink reference signal to the network node (step 1030).

In various embodiments, the request for sidelink reference signal is SR for sidelink reference signal, and/or the request for sidelink reference signal is a triggered and not yet transmitted request for sidelink reference signal, and/or the request for sidelink reference signal is a triggered (may be transmitted) and not yet canceled/discarded request for sidelink reference signal, and/or the first device drops a specific pending request for sidelink reference signal, wherein characteristic(s) of the scheduled one or multiple resources or the one or multiple sidelink reference signal transmissions satisfy information/pattern or requirement of sidelink reference signal associated with the specific pending request for sidelink reference signal.

In various embodiments, the request for sidelink reference signal is MAC CE for sidelink reference signal, which comprises one or more information/patterns or requirements of sidelink reference signal associated with the one or more sidelink reference signal triggering/requesting, and/or the request for sidelink reference signal is a triggered and not yet transmitted MAC CE for sidelink reference signal, and/or the first device updates or re-generates a new MAC CE, wherein the new MAC excludes a specific information/pattern or requirement of sidelink reference signal, wherein characteristic(s) of the scheduled one or multiple resources or the one or multiple sidelink reference signal transmissions satisfy the specific information/pattern or requirement of sidelink reference signal.

Referring back to FIGS. 3 and 4, in one or more embodiments from the perspective of a first device, the device 300 includes a program code 312 stored in memory 310 of the transmitter. The CPU 308 could execute program code 312 to: (i) have one or more sidelink reference signal triggering/requesting for performing one or more sidelink reference signal transmissions, wherein each sidelink reference signal triggering/requesting is associated with its information/pattern or requirement of sidelink reference signal; (ii) trigger to transmit, to a network node, one or more requests for sidelink reference signal, which is utilized for acquiring resources for the one or more sidelink reference signal transmissions; (iii) receive a sidelink grant for scheduling one or multiple resources for the sidelink reference signal; (iv) perform one or multiple sidelink reference signal transmissions on the one or multiple resources; and (v) update or drop (some of) the one or more pending requests for sidelink reference signal, in response to the one or multiple resources or the one or multiple sidelink reference signal transmissions; and transmitting the remaining pending request(s) for sidelink reference signal to the network node. Moreover, the CPU 308 can execute the program code 312 to perform all of the described actions, steps, and methods described above, below, or otherwise herein.

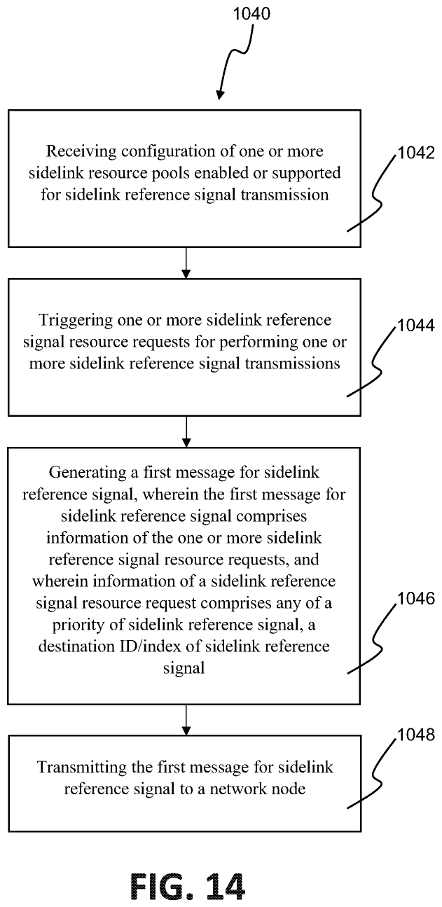

Referring to FIG. 14, with this and other concepts, systems, and methods of the present invention, a method 1040 for a first device in a wireless communication system comprises receiving configuration of one or more sidelink resource pools enabled or supported for sidelink reference signal transmission (step 1042); triggering one or more sidelink reference signal resource requests for performing one or more sidelink reference signal transmissions (step 1044); generating a first message for sidelink reference signal, wherein the first message for sidelink reference signal comprises information of the one or more sidelink reference signal resource requests, and wherein information of a sidelink reference signal resource request comprises (any of) a priority of sidelink reference signal and a destination ID/index of sidelink reference signal (step 1046); and transmitting the first message for sidelink reference signal to a network node (step 1048).

In various embodiments, the information of the sidelink reference signal resource request comprises (any of) the priority of sidelink reference signal, the destination ID/index of sidelink reference signal and a bandwidth (requirement) of sidelink reference signal. In various embodiments, in response to the first device being triggered to perform a first sidelink reference signal transmission, the first device triggers a first sidelink reference signal resource request for performing the first sidelink reference signal transmission; and/or information of the first sidelink reference signal resource request is determined based on a first priority of the first sidelink reference signal transmission, a first destination ID/index of the first sidelink reference signal transmission, and/or a first bandwidth (requirement) of the first sidelink reference signal transmission.

In various embodiments, the destination ID/index of sidelink reference signal identifies destination of the sidelink reference signal.

In various embodiments, when or if the first device performs the triggered first sidelink reference signal transmission, the first device cancels the first sidelink reference signal resource request.

In various embodiments, the first message for sidelink reference signal to the network node is utilized for acquiring or requesting resources for performing the one or more sidelink reference signal transmissions.

In various embodiments, when or if the first device has no available uplink resource for transmitting or accommodating the first message for sidelink reference signal, the first device triggers a SR for the first message for sidelink reference signal; and/or the first device transmits an uplink signaling for the SR to the network node; and/or the SR is utilized for requesting resources for the first message for sidelink reference signal.

In various embodiments, the method further comprises canceling the scheduling request for the first message for sidelink reference signal when or if the first message for sidelink reference signal is included in a MAC PDU and the first device transmits the MAC PDU to the network node.

In various embodiments, the first message for sidelink reference signal means a MAC CE for sidelink reference signal; and/or the sidelink reference signal means sidelink positioning reference signal.

In various embodiments, the first message for sidelink reference signal and a second message for sidelink data are transmitted to the network node; and/or the second message for sidelink data is used to provide the network node with information about sidelink data volume; and/or the second message for sidelink data comprises information of sidelink buffer size and logical channel group ID; and/or the second message for sidelink data means a SL-BSR MAC CE.

In various embodiments, a sidelink grant is received for scheduling one or multiple sidelink resources in a sidelink resource pool enabled or supported for sidelink reference signal transmission; and one or multiple sidelink reference signal transmissions are performed on the one or multiple sidelink resources in the sidelink resource pool.

In various embodiments, the bandwidth (requirement) of sidelink reference signal is in a unit of resource block, sub-channel, or Hertz.

Referring back to FIGS. 3 and 4, in one or more embodiments from the perspective of a first UE, the device 300 includes a program code 312 stored in memory 310 of the transmitter. The CPU 308 could execute program code 312 to: (i) receive configuration of one or more sidelink resource pools enabled or supported for sidelink reference signal transmission; (ii) trigger one or more sidelink reference signal resource requests for performing one or more sidelink reference signal transmissions; (iii) generate a first message for sidelink reference signal, wherein the first message for sidelink reference signal comprises information of the one or more sidelink reference signal resource requests, and wherein information of a sidelink reference signal resource request comprises (any of) a priority of sidelink reference signal and a destination ID/index of sidelink reference signal; and (iv) transmit the first message for sidelink reference signal to a network node. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first device, comprising:
receiving configuration of one or more sidelink resource pools enabled or supported for sidelink reference signal transmission;
triggering one or more sidelink reference signal resource requests for performing one or more sidelink reference signal transmissions;
generating a first message for sidelink reference signal, wherein the first message for sidelink reference signal comprises information of the one or more sidelink reference signal resource requests, and wherein information of a sidelink reference signal resource request comprises a priority of sidelink reference signal and a destination index or Identity (ID) of sidelink reference signal; and
transmitting the first message for sidelink reference signal to a network node.

2. The method of claim 1, wherein:
the information of the sidelink reference signal resource request comprises the priority of sidelink reference signal, the destination index or Identity (ID) of sidelink reference signal, and a bandwidth or bandwidth requirement of sidelink reference signal; and/or
the bandwidth or the bandwidth requirement of sidelink reference signal is in a unit of resource block, sub-channel, or Hertz.

3. The method of claim 2, wherein:
in response to the first device being triggered to perform a first sidelink reference signal transmission, the first device triggers a first sidelink reference signal resource request for performing the first sidelink reference signal transmission; and/or
information of the first sidelink reference signal resource request is determined based on a first priority of the first sidelink reference signal transmission, a first destination index or ID of the first sidelink reference signal transmission, and/or a first bandwidth of the first sidelink reference signal transmission.

4. The method of claim 3, wherein:
when or if the first device performs the triggered first sidelink reference signal transmission, the first device cancels the first sidelink reference signal resource request.

5. The method of claim 1, wherein:
the first message for sidelink reference signal to the network node is utilized for acquiring or requesting resources for performing the one or more sidelink reference signal transmissions.

6. The method of claim 1, wherein:
when or if the first device has no available uplink resource for transmitting or accommodating the first message for sidelink reference signal, the first device triggers a Scheduling Request (SR) for the first message for sidelink reference signal; and/or
the first device transmits an uplink signaling for the SR to the network node; and/or
the SR is utilized for requesting resources for the first message for sidelink reference signal.

7. The method of claim 6, further comprising:
canceling the SR for the first message for sidelink reference signal when or if the first message for sidelink reference signal is included in a Medium Access Control (MAC) Packet Data Unit (PDU) and the first device transmits the MAC PDU to the network node.

8. The method of claim 1, wherein:
the first message for sidelink reference signal means a MAC Control Element (CE) for sidelink reference signal; and/or
the sidelink reference signal means sidelink positioning reference signal.

9. The method of claim 1, wherein:
the first message for sidelink reference signal and a second message for sidelink data are transmitted to the network node; and/or
the second message for sidelink data is used to provide the network node with information about sidelink data volume; and/or
the second message for sidelink data comprises information of sidelink buffer size and logical channel group ID; and/or
the second message for sidelink data means a Sidelink Buffer Status Reporting (SL-BSR) MAC CE.

10. The method of claim 1, wherein:
a sidelink grant is received for scheduling one or multiple sidelink resources in a sidelink resource pool enabled or supported for sidelink reference signal transmission; and
one or multiple sidelink reference signal transmissions are performed on the one or multiple sidelink resources in the sidelink resource pool.

11. A first device, comprising:
a memory; and
a processor operatively connected to the memory, wherein the processor is configured to execute program code to:
receive configuration of one or more sidelink resource pools enabled or supported for sidelink reference signal transmission;
trigger one or more sidelink reference signal resource requests for performing one or more sidelink reference signal transmissions;
generate a first message for sidelink reference signal, wherein the first message for sidelink reference signal comprises information of the one or more sidelink reference signal resource requests, and wherein information of a sidelink reference signal resource request comprises a priority of sidelink reference signal and a destination index or Identity (ID) of sidelink reference signal; and
transmit the first message for sidelink reference signal to a network node.

12. The first device of claim 11, wherein:
the information of the sidelink reference signal resource request comprises the priority of sidelink reference signal, the destination index or Identity (ID) of sidelink reference signal, and a bandwidth or bandwidth requirement of sidelink reference signal; and/or
the bandwidth or the bandwidth requirement of sidelink reference signal is in a unit of resource block, sub-channel, or Hertz.

13. The first device of claim 12, wherein:
in response to the first device being triggered to perform a first sidelink reference signal transmission, the first device triggers a first sidelink reference signal resource request for performing the first sidelink reference signal transmission; and/or
information of the first sidelink reference signal resource request is determined based on a first priority of the first sidelink reference signal transmission, a first destination index or ID of the first sidelink reference signal transmission, and/or a first bandwidth of the first sidelink reference signal transmission.

14. The first device of claim 13, wherein:
when or if the first device performs the triggered first sidelink reference signal transmission, the first device cancels the first sidelink reference signal resource request.

15. The first device of claim 11, wherein:
the first message for sidelink reference signal to the network node is utilized for acquiring or requesting resources for performing the one or more sidelink reference signal transmissions.

16. The first device of claim 11, wherein:
when or if the first device has no available uplink resource for transmitting or accommodating the first message for sidelink reference signal, the first device triggers a Scheduling Request (SR) for the first message for sidelink reference signal; and/or
the first device transmits an uplink signaling for the SR to the network node; and/or
the SR is utilized for requesting resources for the first message for sidelink reference signal.

17. The first device of claim 16, further comprising canceling the SR for the first message for sidelink reference signal when or if the first message for sidelink reference signal is included in a Medium Access Control (MAC) Packet Data Unit (PDU) and the first device transmits the MAC PDU to the network node.

18. The first device of claim 11, wherein:
the first message for sidelink reference signal means a MAC Control Element (CE) for sidelink reference signal; and/or
the sidelink reference signal means sidelink positioning reference signal.

19. The first device of claim 11, wherein:
the first message for sidelink reference signal and a second message for sidelink data are transmitted to the network node; and/or
the second message for sidelink data is used to provide the network node with information about sidelink data volume; and/or
the second message for sidelink data comprises information of sidelink buffer size and logical channel group ID; and/or
the second message for sidelink data means a Sidelink Buffer Status Reporting (SL-BSR) MAC CE.

20. The first device of claim 11, wherein:
a sidelink grant is received for scheduling one or multiple sidelink resources in a sidelink resource pool enabled or supported for sidelink reference signal transmission; and
one or multiple sidelink reference signal transmissions are performed on the one or multiple sidelink resources in the sidelink resource pool.
